(19) United States
(12) Patent Application Publication
(10) Pub. No.: US 2025/0353092 A1
(43) Pub. Date: Nov. 20, 2025

(54) BONDING OF STRUCTURES USING HIGH INTENSITY FOCUSED ULTRASOUND (HIFU)

(71) Applicants: Michael W. Pinch, Seattle, WA (US); University of Washington, Seattle, WA (US); Pinch Engineering PLLC, Kirkland, WA (US)

(72) Inventors: Michael PINCH, Seattle, WA (US); Thomas J. MATULA, Seattle, WA (US); Ekaterina KUZNETSOVA, Seattle, WA (US); Adam D. MAXWELL, Seattle, WA (US); Cody BIRKLAND, Seattle, WA (US); Amy Jean SWANSON, Seattle, WA (US)

(73) Assignees: Michael W. Pinch, Seattle, WA (US); University of Washington, Seattle, WA (US); Pinch Engineering PLLC, Kirkland, WA (US)

(21) Appl. No.: 18/871,610

(22) PCT Filed: Jun. 22, 2023
(86) PCT No.: PCT/US2023/068862

§ 371 Date: Dec. 4, 2024

Related U.S. Application Data
(60) Provisional application No. 63/354,796, filed on Jun. 23, 2022.

(51) Int. Cl. B23K 1/06; B23K 103/00

(52) U.S. Cl. CPC B23K 1/06; B23K 2103/42; B23K 2103/54

(57) ABSTRACT

Methods and systems for bonding of structures using high intensity focused ultrasound are disclosed. In one embodiment, a method for assembling components using ultrasound includes: positioning a first part of an assembly with respect to a second part of the assembly; heating a region of the assembly by focusing the ultrasound from an ultrasound transducer to the region of the assembly; and, in response to heating the region of the assembly, bonding the first part of the assembly to the second part of the assembly.

### CROSS-REFERENCE TO RELATED APPLICATION

This application claims the benefit of U.S. Provisional Application No. 63/354,796, filed Jun. 23, 2022, the disclosure of which is expressly incorporated herein by reference in its entirety.

### BACKGROUND

In many industries, components are bonded together using epoxies or other agents that are cured at elevated temperatures. Typically, the parts to be bonded are placed in ovens for a period of time until the epoxies are cured and bond is established. Often, the ovens heat a much larger volume than the part takes up, therefore wasting a lot of energy. As an example, smaller high-tech electronics products are conveyed through an oven, usually in a batch process. Other examples where epoxy is used within products are: petrochemical, aerospace, and defense/space. Shared among these industries is the use of epoxy to make securely fastened joints between components in a product or machine.

Often, the epoxy is situated within the product under several layers of either metal, glass or plastic. This requires longer diffusion times to conduct the heat from outside to the epoxy itself. Thus, this workflow that requires higher energy loads to cure epoxy used within the product is time and space constrained. Therefore, systems and methods for improved bonding of parts are still needed.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one embodiment, a method for assembling components using ultrasound includes: positioning a first part of an assembly with respect to a second part of the assembly; heating a region of the assembly by focusing the ultrasound from an ultrasound transducer to the region of the assembly; and in response to heating the region of the assembly, bonding the first part of the assembly to the second part of the assembly.

In one aspect, the first part of the assembly and the second part of the assembly are at least partially separated by a gap filled with a bonding agent, and heating the region comprises heating the bonding agent.

In one aspect, the bonding agent is an epoxy.

In another aspect, the bonding agent is a solder.

In one aspect, the method also includes debonding the region of the assembly by focusing ultrasound from the ultrasound transducer to the region of the assembly.

In one aspect, the ultrasound is focused to the bonding agent.

In another aspect, the ultrasound is focused to the first part of the assembly or the second part of the assembly, and the bonding agent is heated up by the first part of the assembly or the second part of the assembly.

In one aspect, the ultrasound is focused to the bonding agent, the first part of the assembly or the second part of the assembly through an interleaving material of the assembly.

In one aspect, the ultrasound transducer is configured to transmit the ultrasound to the assembly through a fluid coupler that couples the ultrasound transducer to the assembly.

In one aspect the method also includes: attaching the ultrasound transducer to the assembly by a vacuum; and cooling the fluid coupler or the ultrasound transducer by a coolant.

In one aspect, the ultrasound transducer is configured to transmit the ultrasound to the assembly through a solid coupler that couples the ultrasound transducer to the assembly.

In another aspect, the ultrasound transducer is configured to transmit the ultrasound to the assembly through a lens.

In one aspect, the lens is a holographic lens.

In another aspect, holographic features of the holographic lens are included on a surface of an internal component of the assembly, wherein the internal component is located in a path of the ultrasound.

In one aspect, the method also includes: determining a return echo of the ultrasound emitted by the ultrasound transducer; and based on the return echo, deciding whether bonding the first part of the assembly to the second part of the assembly is complete.

In another aspect, the method also includes determining a return echo of the ultrasound emitted by the ultrasound transducer; and based on the return echo, deciding whether debonding the first part of the assembly to the second part of the assembly is complete.

In one embodiment, a system for assembling components using ultrasound includes: an ultrasound transducer configured for transmitting the ultrasound toward an assembly having a first part and a second part. The ultrasound is configured for heating a region of the assembly by focusing the ultrasound from the ultrasound transducer to the region of the assembly. In response to heating the region of the assembly, the first part of the assembly to the second part of the assembly are bonded.

In one aspect, the first part of the assembly and the second part of the assembly are at least partially separated by a gap filled with a bonding agent that is configured for bonding the first part of the assembly and the second part of the assembly in response to heating the region.

In one aspect, the bonding agent is an epoxy or a solder.

In one aspect, the system also includes a holographic lens configured to focus the ultrasound on the assembly.

In another aspect, the holographic lens is a part of the assembly.

In one aspect, the system also includes a coupler configured for acoustically coupling the ultrasound transducer to the assembly, wherein the coupler is a fluid coupler or a solid coupler.

In one aspect, the system includes a coolant configured for cooling the coupler.

In another aspect, the system includes: a coupler containment shell configured for holding the coupler; a membrane configured for separating the coupler from the assembly; an outer containment shell; a vacuum conduit configured for connecting a source of vacuum to a space between the coupler containment shell and the outer containment shell; a vacuum seal configured for sealing the outer containment shell against the assembly; a coolant inlet conduit configured for providing the coolant to the system; and a coolant outlet conduit configured for evacuating the coolant.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a partially schematic view of an ultrasound bonding system in accordance with embodiments of the present technology;

FIG. 2 is a partially schematic view of an ultrasound bonding system in accordance with embodiments of the present technology;

FIG. 3 is a partially schematic view of an ultrasound bonding system placed in contact with a target assembly in accordance with embodiments of the present technology;

FIG. 4 is a partially schematic view of an ultrasound bonding system that includes a liquid coupling in accordance with embodiments of the present technology;

FIG. 5 is an isometric view of an ultrasound bonding system capable of a vacuum-based contact with a target assembly in accordance with embodiments of the present technology;

FIGS. 6A-6D illustrate different bonding shapes in accordance with embodiments of the present technology;

FIG. 7 is a side cross-sectional view of an ultrasound bonding system that includes a lens in accordance with embodiments of the present technology;

FIG. 7A is a detail view of FIG. 7;

FIG. 8 is a side cross-sectional view of an ultrasound bonding system that includes a holographic lens in accordance with embodiments of the present technology;

FIG. 8A is a detail view of FIG. 8;

FIG. 8B shows a surface of holographic lens of FIG. 8;

FIG. 9A is a top view of a key FOB assembly in accordance with embodiments of the present technology; and

FIG. 9B is a thermal map of the key FOB assembly in accordance with embodiments of the present technology.

### DETAILED DESCRIPTION

While illustrative embodiments have been illustrated and described, it will be appreciated that various changes can be made therein without departing from the spirit and scope of the invention.

Acoustic waves can transfer energy to cause heating of targets placed in an acoustic field. Therefore, ultrasound may be used to transfer heat energy from a transducer to a target area of an assembly. High Intensity Focused Ultrasound (HIFU) is a technique that uses one or more ultrasonic transducers to heat a small region at the transducer's focus. For example, epoxy or solder may be applied between parts of an assembly in an area where the bond is to be created. Next, one or more transducers or transducer elements of a phased array transducer may be focused at the bond site, therefore heating epoxy and curing it in situ. Parts that can be bonded include metals and plastics, or composites, or other materials and combinations thereof.

In some embodiments, parts can be bonded without an additional bonding agent based on, for example, localized melting of the parts under the ultrasound field, followed by solidification and joining of the parts. Such joining of the parts without a bonding agent may be applicable to parts or subassemblies made of rubber, plastics, or other materials with a relatively low melting point. In different embodiment, conventional lenses and/or holographic lenses may be used.

Unlike the ultrasound welding which is predicated on the ultrasound-induced vibration of parts resulting in their localized mechanical friction caused by relative motion of one part against another, the present technology is based on a transfer of ultrasound acoustic energy into heat via absorption of acoustic energy at the focal zone. In general, HIFU generates nonlinear acoustic waves, which are comprised of multiple frequencies (harmonics). The higher frequency components get absorbed more. Hence, the energy transfer takes place primarily near/at the focus of the ultrasound, where the energy density is highest and the higher harmonics that are generated along the way get absorbed. This process also minimized heating of the nearby area.

Therefore, with HIFU, the total acoustic pressure amplitude is of a high value only in the focus region where localized heating occurs. The near-field intensity can be focused to a spot at the interior of the assembly. In contrast to the HIFU heating, the ultrasonic welding is characterized by high acoustic field intensity all the way from a sonotrode (horn or transducer of the ultrasonic welding apparatus) at the outer surface of the part to the weld location inside the assembly. With traditional ultrasonic welding, an energy director is a necessary ingredient in the process. One of the mating parts needs to have an energy director to allow the vibrational energy to be focused at that location. Without such a feature in the part, the ultrasound welding process will not work. Moreover, the location of the weld is co-located with this energy director feature. With the inventive technology, it is not necessary to have an energy director or other feature to allow the process to happen. The ultrasound acoustic energy is emitted by the transducer and absorbed by the target objects and/or bonding agent preferentially at the focal zone, therefore creating thermal conditions for bonding of the parts. Such thermal conditions generally include reaching a predetermined temperature for a duration of time at the target zone.

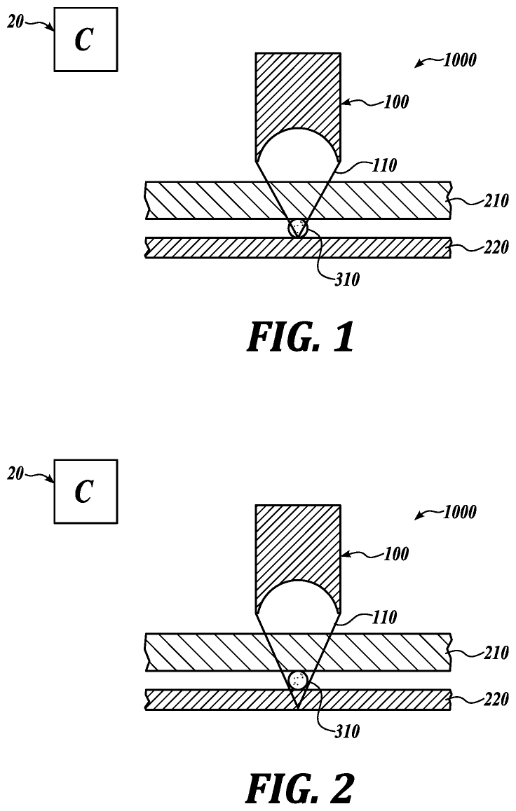

FIGS. 1 and 2 are partially schematic views of ultrasound bonding systems in accordance with embodiments of the present technology. Illustrated bonding system 1000 includes an ultrasound transducer 100, which may be a monolithic ultrasound transducer or a phased array ultrasound transducer. In some applications, multiple ultrasound transducers 100 may be used to direct ultrasound field onto parts 210, 220 and/or bonding agent 310. The parts 210, 220 may be flat or curved plastic, glass, metal or other material. For simplicity, we only show two parts 210, 220 to be bonded. However, a person of ordinary skill would understand that there may be several layers of similar or dissimilar materials, with the epoxy being disposed in one or more of the locations among the parts to be bonded.

For one or a few spots of epoxy, a single element transducer 100 may be used. However, if multiple spots of epoxy, or larger regions of epoxy need to be cured, a transducer or an array of transducers 100 may be scanned either manually or electronically to heat larger areas, or multiple epoxy ‘spots’. The motion of one or more transducers, their operating frequency, amplitude, duty factor, etc., may be controlled by a controller 20. In operation, the frequency may vary from, for example, 20 kHz to 50 MHz or greater based on the volume and precision of the cured area required, as well as the absorption of the epoxy. The intensity may vary from approximately 1 W/cm2 to more than 10 kW/cm2 at the focus area with energy applied to a single location for duration of 10 ms-1000 seconds. The ultrasound may be continuously applied, or may be pulsed to modulate the time-averaged intensity with a duty factor of 1-100%. The transducer may be designed to create a nonlinear waveform at the focus to maximize absorption with the same applied energy, increasing the efficiency and potential precision of the process. These nonlinear waveforms act to transfer energy from the ultrasound waveforms to heat at the parts and/or bonding agent that are located at the focus of the ultrasound field. However, such transfer of energy is not accompanied by the ultrasound-induced vibration of parts resulting in their localized mechanical friction caused by the relative movement of one part against another, as is typically done in the ultrasound welding of metal parts. By changing the degree of nonlinearity simultaneously with the duty factor, the precision and focusing of energy can be altered over a range of parameters with a single transducer and frequency of application.

In some cases, a piezoelectric phased array transducer may be used to sonicate multiple different locations in sequence to produce uniform heating over a larger area than with a single focal volume. In another embodiment, an unfocused transducer may be used with a replaceable attached lens to produce focusing at different depths and to couple to different materials. In further embodiments, the acoustic field 110 may be channeled through a cone that acts as a waveguide structure that concentrates ultrasound energy and couples the ultrasound energy to a like material for efficient energy transfer into the adjacent object. In some embodiments, a standing-wave may be preferable to control the precise axial location of heating to precisely heat a thin layer while minimally affecting directly adjacent materials. In addition to bonding the parts based on heat produced by focusing ultrasound at a target location, debonding based on ultrasound is also possible. For example, such debonding may be achieved via cavitation or through chemical degradation of the bonding agent via heat, or by remelting solder that connects different components.

In operation, the acoustic energy passes through any interleaving materials and is focused at or near the bond region. FIG. 1 illustrates a case where the ultrasound is focused to the epoxy itself. FIG. 2 illustrates a case where the ultrasound is focused to a zone that is in the vicinity of the epoxy, however, still sufficiently heating the surrounding area including the pre-positioned epoxy (or other bonding agent).

The bonding agents may be adhesives, such as solders or epoxies. Other heat-activated adhesives are also possible. Some examples of adhesives used in the medical implant industry are: polymethyl methacrylate (PMMA), polyurethanes, and glass ionomers cements.

Epoxies are typically provided in one of two general categories: two-part epoxies and one-part epoxies, difference being in the chemical composition, and how the polymerization is initiated. In the case of a two-part epoxy, the second part is the hardener which is mixed to the first part just before use. For one-part epoxy, a thermal initiator is pre-mixed with the resin and is presented to the user as a single-part in one container. One-part epoxy is typically characterized by a somewhat higher curing temperature, typically at or above 100° C.

One-part epoxy can be stored for a long time at room temperature as well as at reasonably high storage temperature. That is, refrigeration is not needed in most cases. In some embodiments, this behavior of one-part epoxy may be advantageous, because an end user may cure the epoxy on demand, thus allowing more flexibility in the implementation of the inventive technology on an assembly line. Analogously, two-part epoxies can also be used. Processes that involve robotic application of the epoxies may also be used when implementing high intensity focused ultrasound (HIFU) bonding.

In operation, one or more ultrasound transducers 100 emit ultrasound in an ultrasound field 100 that is focused on a bonding agent (e.g., an epoxy or solder) 310 as in FIG. 1, or on an area that is proximate to the bonding agent 310 as in FIG. 2. Under either scenario, the ultrasound acoustic field increases the temperature of the bonding agent 310 to a value that initiates the bonding process. The endpoint of the process may be determined either by prior studies providing a time/intensity profile for curing (as is currently done with ovens), or with real-time monitoring of the cure using, e.g., pulsed acoustic echoes. For example, as epoxy cures, the echoes (i.e., amplitude and/or phase of the returning ultrasound) will change. Prior calibration of the echo signals vs. epoxy cure state allows one to monitor the curing process. Thus, ultrasound imaging (echo based, or otherwise) may be used to guide the process of ultrasound bonding. Ultrasound may be applied until the epoxy is cured, or until a predetermined temperature or curing time is achieved. The ultrasound transducer 100 may include acoustic lens for improved focusing and/or coupling of the ultrasound.

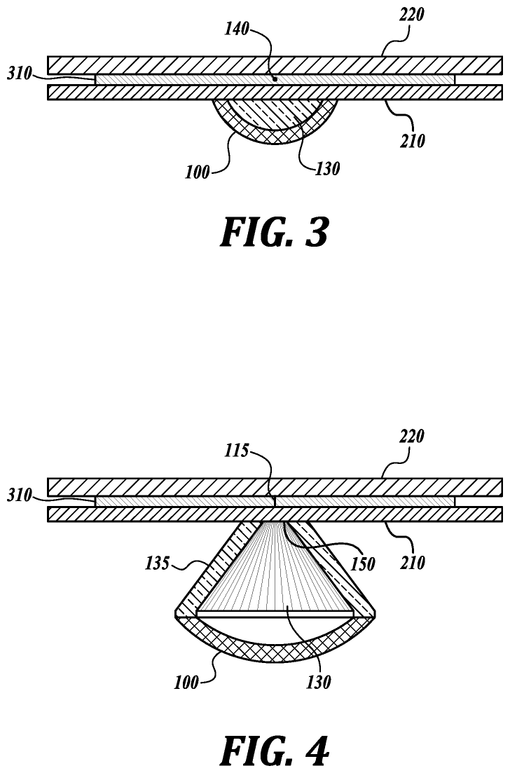

FIG. 3 is a partially schematic view of an ultrasound bonding system placed in contact with a target assembly in accordance with embodiments of the present technology. Here, the transducer 100 sits against the bottom portion of part 210. A layer of a bonding agent (e.g., an epoxy) 310 is disposed between parts 210 and 220. When the bonding agent 310 is cured, parts 210 and 220 are bonded together. In different embodiments, parts 210, 220 may be made of plastic, metal, rubber, glass or other materials.

In operation, the transducer 100 focuses acoustic energy through a coupling media 130, through the part 210 and onto a focus region 140, where the bonding agent is heated by the ultrasound acoustic waveforms. As explained with respect to FIG. 2 above, in some situations the focus of the ultrasound field may extend into one or more parts 210, 220 which, having been heated by the ultrasound field, heat the bonding agent 310. This indirect heating method may be preferable in some embodiments.

The coupling media 130 may be a liquid, gel or solid. Different coupling media will be suitable for different types of transducers 100 and/or parts 210, 220. Some examples of liquid coupling media include water, oil, and perfluorocarbon. However, other coupling media may be suitable to couple the ultrasound between the transducer and the components that the transducer is placed against.

FIG. 4 is a partially schematic view of an ultrasound bonding system that includes a liquid coupling in accordance with embodiments of the present technology. This embodiment is analogous to the one illustrated in FIG. 3, however, here the transducer 100 is set apart from the part 210 by a coupler containment shell (also referred to as a cone) 135. In some embodiments, an additional distance from the ultrasound transducer 100 to the bonding agent 310 may improve focusing of the ultrasound. Having a separation with a cone 135 may allow for more design latitude of the transducer 100 (e.g., in terms of shape, size) if the outer surface of the part has a different size, scale or unusual shape. The coupler containment shell 135 may be made of a plastic, metal or other materials. Illustrated bonding system may also include a membrane 150 that seals the space between the coupler 130 and the parts 210, 220.

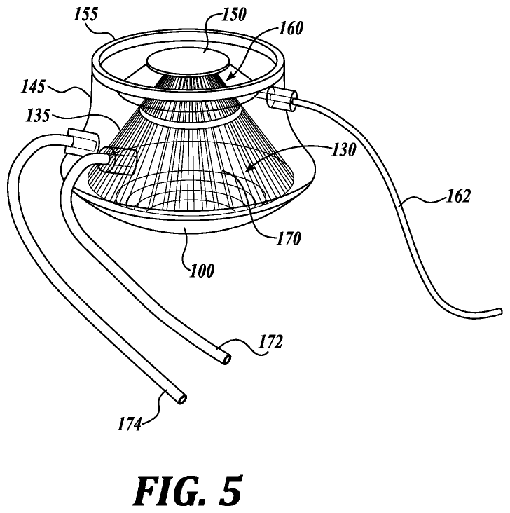

FIG. 5 is an isometric view of an ultrasound bonding system capable of a vacuum-based contact with a target assembly in accordance with embodiments of the present technology. In the illustrated ultrasound bonding system, the ultrasound transducer 100 is mounted to a water-tight coupler containment shell 135, which may be filled with coupler 130. In some applications, coupler 130 may be liquid such as water that provides coupling between the ultrasound transducer 100 and part(s) to be bonded. In operation, the acoustic energy enters the parts to be bonded via the membrane 150, which may be a thin rubber or plastic (e.g., saran wrap). In some applications, the coupler 130 may be a gel. Depending on the viscosity and density of the couplers 130, these couplers may or may not require a coupler containment shell 135 to hold the coupler between the ultrasound transducer 100 and parts to be bonded. In other implementations, the coupler 130 may be made of plastic or metal that allows the acoustic energy to propagate through the coupler and into the parts to be bonded.

In some applications, the ultrasound energy generated by the ultrasound transducer 100 may be partially dissipated within the coupler 130. Therefore, the coupler 130 may be cooled by, for example, water 170 that is provided through a coolant inlet conduit (e.g., a hose or tube) 172 and a coolant outlet conduit 174 (e.g., a hose or tube) into an outer containment shell 145, therefore convectively cooling the coupler containment shell 135. The illustrated ultrasound system may be attached to the parts to be bonded by a vacuum 170 between the membrane 150 and a vacuum seal 155. A vacuum conduit (e.g., a hose or tube) 162 may connect a source of vacuum to the space between the coupler containment shell 135 and the outer containment shell 145.

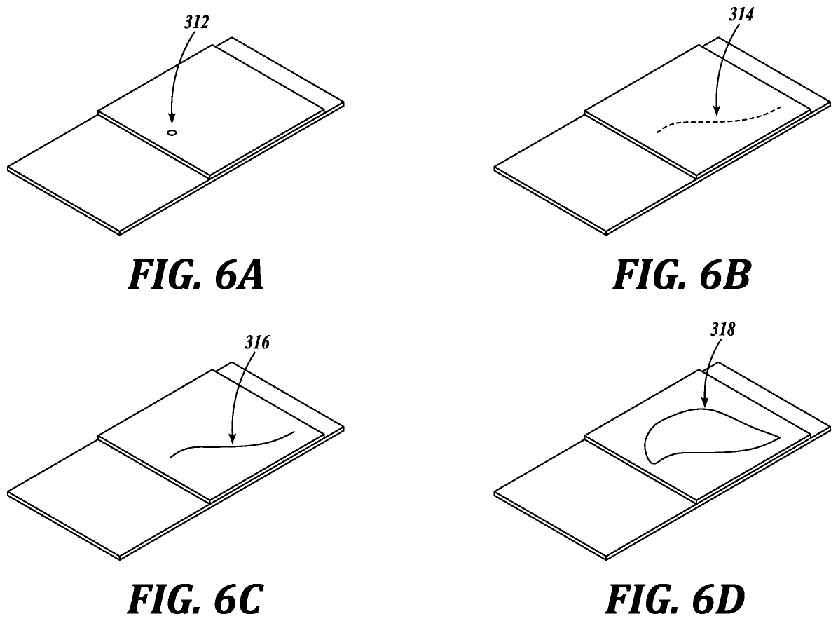

FIGS. 6A-6D illustrate different bonding shapes in accordance with embodiments of the present technology. In each figure, the bonding agent (e.g., epoxy, solder) is configured over a flat surface, however, in different implementations the target bonding surface may be either flat or curved. In some implementations, a physical application of the bonding agent over the target part may be accompanied with updating a so-called digital twin of the product. For example, a computer aided design software may have a 3D model of the target product in its memory. Bonding process may rely on predefined datum scheme to control targeting of the parts to be bonded. Next, after the application of the bonding agent and its curing, the 3D model gets updated to reflect the newly established physical reality of the target parts.

FIG. 6A illustrates a bonding agent that is applied as a spot 312. FIG. 6B illustrates a bonding agent that is applied as a series of spots that form a stitched line 314. FIG. 6C illustrates a bonding agent that is applied as a series of spots that are connected such that those spots form a curvilinear line 316. FIG. 6D illustrates a bonding agent that is applied in an area region 318. Such area region 318 may be two-dimensional (2D) or three-dimensional (3D).

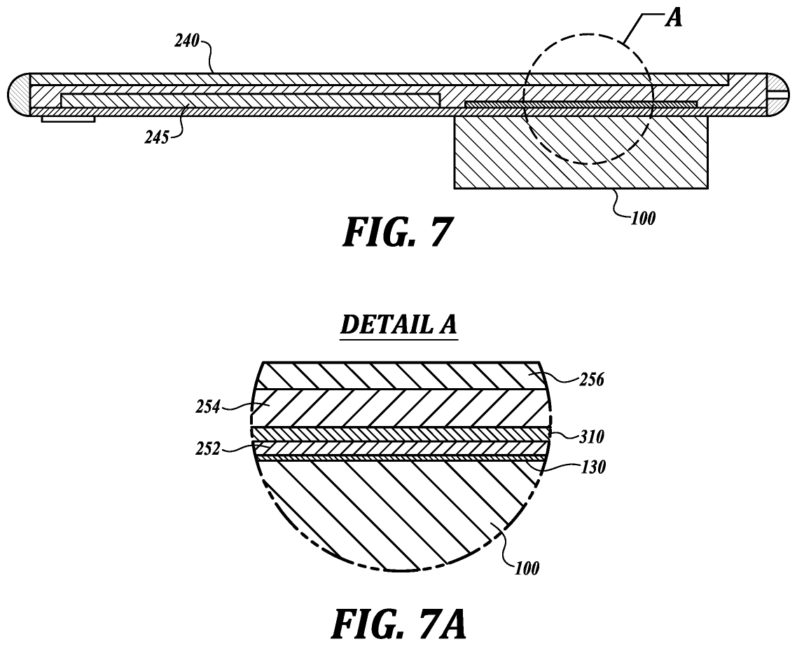

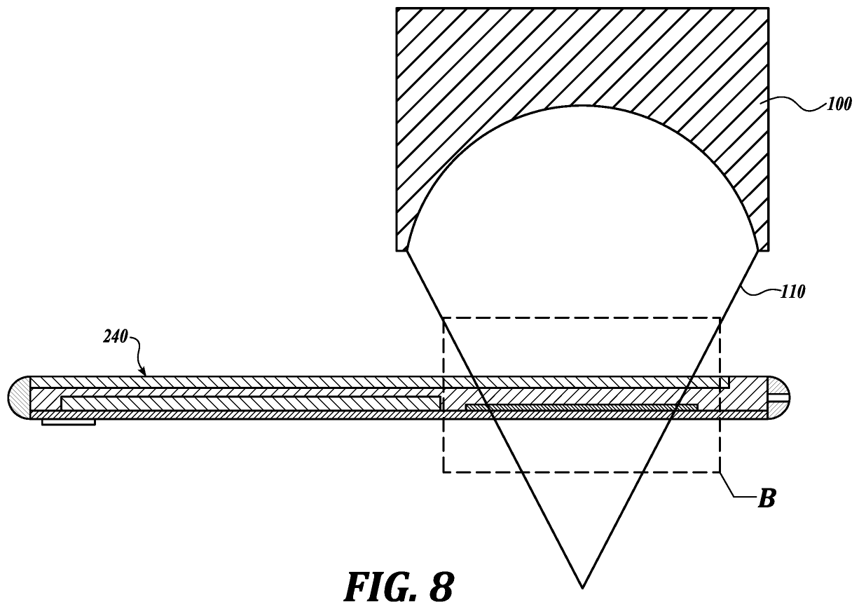

FIG. 7 is a side cross-sectional view of an ultrasound bonding system that includes a lens in accordance with embodiments of the present technology. With the illustrated bonding system, the ultrasound transducer 100 is planar, but non-planar ultrasound transducers are also possible. Illustrated target object 240 is a smartphone, however, in different embodiments different target objects are possible.

FIG. 7A is a detail view of FIG. 7. Here, the bonding agent 310 is configured between internal component 252, which may be a plastic enclosure, and internal component 254, which may be made of molded plastic. The ultrasound transducer 100 is connected to the target object 240 with the coupler 130. In operation, the acoustic field is focused onto the bonding agent 310 that is disposed between the internal components 252, 254 (e.g., molded plastic, plastic enclosure, sheet metal, glass, etc.) to heat up the bonding agent 310. During this process, a thermally sensitive component 256 is protected against excessive heating by being away from the focus of the acoustic field. Such thermal protection of component 256 would not be possible with the conventional oven-based heating.

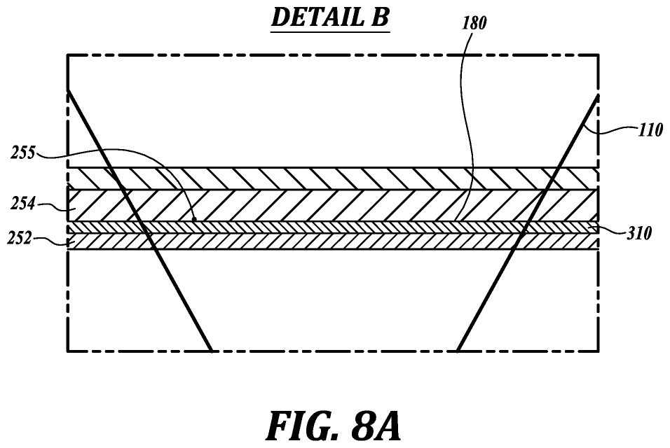

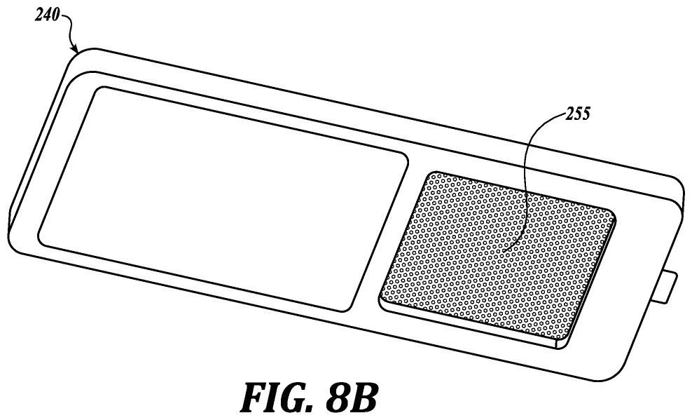

FIG. 8 is a side cross-sectional view of an ultrasound bonding system that includes a lens in accordance with embodiments of the present technology. The illustrated target object 240 is a phone. In operation, the ultrasound transducer 100 emits ultrasound field 110 toward the target object.

FIG. 8A is a detail view of FIG. 8. In the illustrated embodiment, a holographic lens is configured in the path of the ultrasound field 110. For example, surface 255 of the internal component 254 may act as a holographic lens. In general, a holographic lens includes a series of holographic features (e.g., differently shaped hills, valleys, gratings, etc.) on its surface such that, when exposed to acoustic field, these holographic features act as additional refractive sources of acoustic waves that constructively or destructively combine amplitudes of the acoustic field at the target areas, which is the area of the bonding agent 310 in this application. Based on this constructive/destructive amplitude combinations, different acoustic signatures, resulting in different thermal and/pressure fields, can be imparted on the bonding agent 310.

Therefore, as explained above, one of the parts of the target object 240, e.g., the internal component 254, may have an additional function of a holographic lens. In other embodiments, the holographic lens may be an additional component that is purposefully added to the assembly of the target object 240. In different applications, such added holographic lens may be removable after the assembly, or may be left inside the target object 240 after the assembly. FIG. 8B shows the surface 255 of the holographic lens (or an internal component) 254.

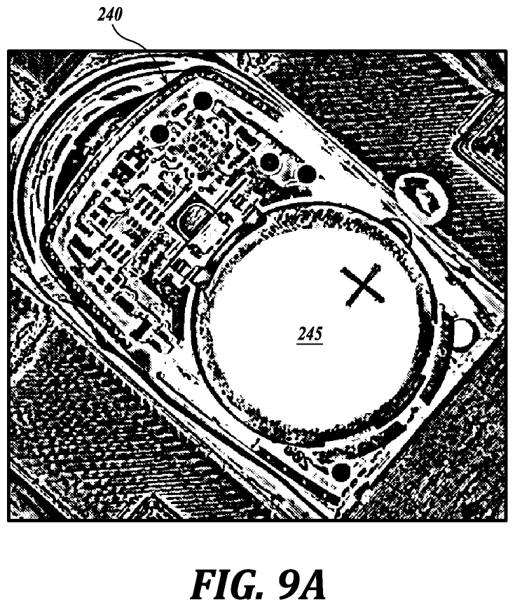

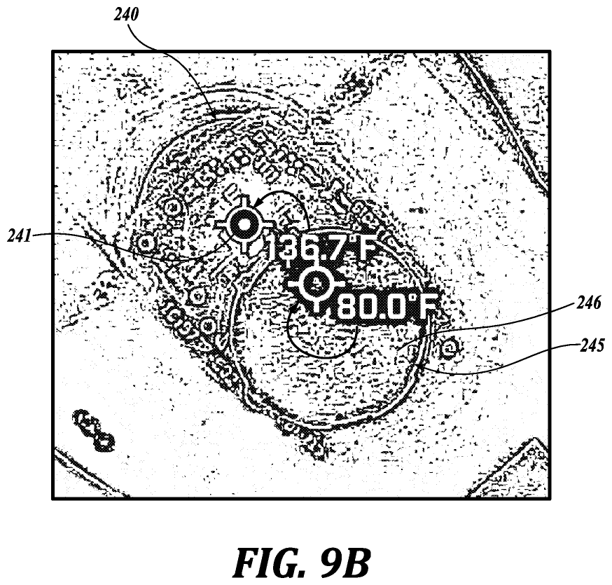

FIG. 9A is a top view of a key FOB assembly 240 in accordance with embodiments of the present technology. In this particular application, bonding of the internal parts has to be executed such that a thermally fragile component (a lithium-ion battery) remains at a relatively low temperature during the application of the ultrasound acoustic field. To measure the temperatures of the internal parts, the upper part of a key FOB is exposed by removing the cover. The bottom of the FOB is in contact with water, which serves as the coupler for the ultrasound transducer, while the top surface of the FOB is exposed to air. In operation, a source of acoustic field (HIFU) is positioned under the key FOB and is focused at the key FOB. In some applications, the embodiment illustrated in FIG. 4 may be more suitable for the illustrated purpose, as the part would not have to be in contact with a liquid coupling agent. A thermal camera recorded the surface temperature during the bonding process. The temperature field obtained during the bonding process is discussed below in reference to FIG. 9B.

FIG. 9B is a thermal map of the key FOB assembly in accordance with embodiments of the present technology. As explained above, the ultrasound passed through water (coupler) and then through different layers of the key FOB before heating its top, exposed surface.

Epoxies are often kept at around 100 F in an oven to cure. In the illustrated operation, a target area 241 reached a temperature of 136.7 F, which is above a typical value of 100 F required for curing an epoxy, while area 246 of the lithium-ion battery 245 remained at 80 F, which is within the allowed range of temperature for such batteries. Therefore, the measurements demonstrate the capability of the inventive technology to selectively heat target areas, while keeping the sensitive areas within the safe temperature range.

The terms used in the embodiments of the present disclosure are merely for the purpose of describing specific embodiment, rather than limiting the present disclosure. The terms “a”, “an”, “the”, and “said” in a singular form in the embodiments of the present disclosure and the attached claims are also intended to include plural forms thereof, unless noted otherwise.

Many embodiments of the technology described above may take the form of computer- or controller-executable instructions, including routines executed by a programmable computer or controller. Those skilled in the relevant art will appreciate that the technology can be practiced on computer/controller systems other than those shown and described above. The technology can be embodied in a special-purpose computer, controller or data processor that is specifically programmed, configured or constructed to perform one or more of the computer-executable instructions described above. Such computers, controllers and data processors may include a non-transitory computer-readable medium with executable instructions. Accordingly, the terms “computer” and “controller” as generally used herein refer to any data processor and can include Internet appliances and hand-held devices (including palm-top computers, wearable computers, cellular or mobile phones, multi-processor systems, processor-based or programmable consumer electronics, network computers, mini computers and the like).

From the foregoing, it will be appreciated that specific embodiments of the technology have been described herein for purposes of illustration, but that various modifications may be made without deviating from the disclosure. Moreover, while various advantages and features associated with certain embodiments have been described above in the context of those embodiments, other embodiments may also exhibit such advantages and/or features, and not all embodiments need necessarily exhibit such advantages and/or features to fall within the scope of the technology. Where methods are described, the methods may include more, fewer, or other steps. Additionally, steps may be performed in any suitable order. Accordingly, the disclosure can encompass other embodiments not expressly shown or described herein. In the context of this disclosure, the term “about,” approximately” and similar means +/−5% of the stated value.

For the purposes of the present disclosure, lists of two or more elements of the form, for example, “at least one of A, B, and C,” is intended to mean (A), (B), (C), (A and B), (A and C), (B and C), or (A, B, and C), and further includes all similar permutations when any other quantity of elements is listed.

1. A method for assembling components using an ultrasound, the method comprising:
positioning a first part of an assembly with respect to a second part of the assembly;
heating a region of the assembly by focusing the ultrasound from an ultrasound transducer to the region of the assembly, wherein heating of the region is based on transferring ultrasound acoustic energy into heat via absorption of ultrasound acoustic energy at a focal zone corresponding to the region of the assembly; and
in response to heating the region of the assembly, bonding the first part of the assembly to the second part of the assembly.

2. The method of claim 1, wherein the first part of the assembly and the second part of the assembly are at least partially separated by a gap filled with a bonding agent, and wherein heating the region comprises heating the bonding agent.

3. The method of claim 2, wherein the bonding agent is an epoxy.

4. The method of claim 2, wherein the bonding agent is a solder.

5. The method of claim 2, further comprising debonding the region of the assembly by focusing the ultrasound from the ultrasound transducer to the region of the assembly.

6. The method of claim 2, wherein the ultrasound is focused to the bonding agent.

7. The method of claim 2, wherein the ultrasound is focused to the first part of the assembly or the second part of the assembly, and wherein the bonding agent is heated up by the first part of the assembly or the second part of the assembly.

8. The method of claim 1, wherein heating the region of the assembly by focusing the ultrasound from the ultrasound transducer to the region of assembly further comprises the ultrasound passing through an interleaving material between the ultrasound transducer and the region of assembly.

9. The method of claim 1, wherein the ultrasound transducer is configured to transmit the ultrasound to the assembly through a fluid coupler that couples the ultrasound transducer to the assembly.

10. The method of claim 9, further comprising:
attaching the ultrasound transducer to the assembly by a vacuum; and
cooling the fluid coupler or the ultrasound transducer by a coolant.

11. The method of claim 1, wherein the ultrasound transducer is configured to transmit the ultrasound to the assembly through a solid coupler that couples the ultrasound transducer to the assembly.

12. The method of claim 1, wherein the ultrasound transducer is configured to transmit the ultrasound to the assembly through a lens.

13. The method of claim 12, wherein the lens is a holographic lens.

14. The method of claim 13, wherein holographic features of the holographic lens are included on a surface of an internal component of the assembly, wherein the internal component is located in a path of the ultrasound.

15. The method of claim 1, further comprising:
determining a return echo of the ultrasound emitted by the ultrasound transducer; and
based on the return echo, deciding whether bonding the first part of the assembly to the second part of the assembly is complete.

16. The method of claim 5, further comprising:
determining a return echo of the ultrasound emitted by the ultrasound transducer; and
based on the return echo, deciding whether debonding the first part of the assembly to the second part of the assembly is complete.

17. A system for assembling components using an ultrasound, comprising:
an ultrasound transducer configured for transmitting the ultrasound toward an assembly having a first part and a second part,
wherein the ultrasound is configured for heating a region of the assembly by focusing the ultrasound from the ultrasound transducer to the region of the assembly, wherein heating of the region is based on transferring ultrasound acoustic energy into heat via absorption of ultrasound acoustic energy at a focal zone corresponding to the region of the assembly, and
wherein, in response to heating the region of the assembly, the first part of the assembly to the second part of the assembly are bonded.

18. The system of claim 17, wherein the first part of the assembly and the second part of the assembly are at least partially separated by a gap filled with a bonding agent that is configured for bonding the first part of the assembly and the second part of the assembly in response to heating the region.

19. The system of claim 17, wherein the bonding agent is an epoxy or a solder.

20. The system of claim 17, further comprising a holographic lens configured to focus the ultrasound on the assembly.

21. The system of claim 20, wherein the holographic lens is a part of the assembly.

22. The system of claim 17, further comprising a coupler configured for acoustically coupling the ultrasound transducer to the assembly, wherein the coupler is a fluid coupler or a solid coupler.

23. The system of claim 22, further comprising a coolant configured for cooling the coupler.

24. The system of claim 23, further comprising:
a coupler containment shell configured for holding the coupler;
a membrane configured for separating the coupler from the assembly;
an outer containment shell;
a vacuum conduit configured for connecting a source of vacuum to a space between the coupler containment shell and the outer containment shell;
a vacuum seal configured for sealing the outer containment shell against the assembly;
a coolant inlet conduit configured for providing the coolant to the system; and
a coolant outlet conduit configured for evacuating the coolant.
